(19) United States
(12) Patent Application Publication
(10) Pub. No.: US 2012/0173285 A1
(43) Pub. Date: Jul. 5, 2012

(54) Proactive Clinical Evidence at Point of Care and Genomic Data Integration through Cloud EMR Media

(76) Inventor: Suresh Muthukrishnan, Doha (QA)

(21) Appl. No.: 13/161,746

(22) Filed: Jun. 16, 2011

Related U.S. Application Data
(60) Provisional application No. 61/429,856, filed on Jan. 5, 2011.

(51) Int. Cl. G06Q 50/00; G06Q 10/00

(52) U.S. Cl. 705/3; 705/2

(57) ABSTRACT

Online Electronic Medical Record and Clinical decision support system Cloud SaaS model. Method of storing electronic patient medical information for a patient is provided which includes creating a unique patient identifier for the patient, storing the electronic patient medical record data for the patient using the unique patient identifier for the patient and creating a family linkage using unique patient identifiers to connect individual medical records of relatives of the patient. The electronic patient medical information can be shared between, a network, of a plurality of healthcare institutions, individual healthcare service providers and patients. Individual healthcare providers or patients can request for the stored electronic patient medical record data and obtain the electronic patient medical record data along with the family linkage information to at least one of the plurality of healthcare providing institutions, individual healthcare providers or patients.

### CROSS-REFERENCE TO RELATED APPLICATION

This application claims priority to U.S. Provisional Application No. 61/429,856, filed on Jan. 5, 2011, the complete disclosure of which, in its entirety, is herein incorporated by reference.

### FIELD OF INVENTION

The present invention relates to health information management, and in particular to a system that enables multiple medical practitioners, and medical service providers to store, retrieve, distribute patient medical records over internet using a common patient identifier, provide clinical decision support based on medical evidences available in the patient record archives within the system, family history of patients from blood relatives' records within the system, as well as information on drugs and services provided by various services providers mapped to standard codings such as ICD 10 or SNOMED.

### BACKGROUND OF INVENTION

The clinical journey of a patient may involve healthcare service providers, belonging to multiple and unconnected individuals or organizations or institutions located in multiple geographic locations. Currently there are no means to centrally manage patient's medical records/information generated from the multiple healthcare providers. The healthcare service provider could be a healthcare institution, individual practicing as a general practitioner, a specialist, a visiting consultant in a polyclinic, a private clinical lab or a radiological scan center, a tertiary care surgical center among others. Even if a single medical episode of a patient is completely captured by a single institution providing all the services in their in house hospital information systems or EMRs, the medical information recorded during this episode still remains unavailable when the patient has another episode handled by another service provider probably in a different geographic location. In many cases, there are just no medical records available for a patient or for a particular medical episode of a patient.

Family medical history can contribute greatly in clinical diagnosis and treatment plans. This includes information of blood related family members belonging to larger family tree spread over generations vertically as well as current generations in the horizontal direction like blood related second families, etc.

There is no single platform that can possibly capture, store and distribute medical information of a patient as well as all the blood connected relatives gathered during same or different timings in their life cycle by different medical service providers over a single or many medical episodes at same or different geographic locations.

Evidence based medicine in general is becoming increasingly popular as it improves clinical decision and quality of healthcare delivery while reducing healthcare costs and turnaround time. Clinical evidence knowledge sharing is vital as there is a continuous growth or evolution in medical practices, technology changes, newer techniques, newer drugs, newer diseases etc. It is practically impossible for a practicing clinician to acquire this knowledge in advance while there is constant need of newer information at the point of care in their routine practice. Clinicians are always left with questions or doubts in routine practice that go unanswered.

Even though there are many systems that allow query to databases containing publications, guidance, and recommended care pathways, currently there is no system that will let a physician at point of care know about and give access (with appropriate access rights and permissions) to actual medical records of other patients with similar clinical conditions treated by other physicians from other institutions located elsewhere in order to understand the best practices adopted by them in successful management of similar clinical conditions, or provide proactive statistical information on the incidence of the observed clinical symptom or suspected diagnosis among a family genome or a region etc., based on the records available in the system.

According to many studies and analysis, medication errors happen mostly while prescribing by the clinician at point of care. This is due to various reasons like inadequate drug information like not knowing both the generic name and trade names of drugs, improper calculation of dosage based on age, sex, body weight, contraindications, drug interactions, combination of molecules in a trade drug etc. Clinician is expected to take into account of all these at point of care before prescribing, which is a difficult task.

Though there are many drug reference and database systems available as libraries, there are no systems to proactively list at the point of care with a set of drugs connected to the observed clinical symptom, findings or illness, automatically calculate dosage based on patient age and weight upon prescription of the same, provide alerts/warnings on contraindications, drug interactions, regulatory stipulations and provide statistical usage of such drugs for the connected clinical finding from the available records, etc., Also there are no means for a drug or pharma firm to monitor drug utilization pattern, introduce or withdraw drugs online at the point of care.

Information on post medical care recovery is vital for concluding the effectiveness of the treatment or a drug or determining the prognosis which will help physicians determine whether to attempt certain treatments or withhold them or modify the treatment. This information is unavailable in most cases and not captured in the medical records as patients may not follow up on care with the same physician or simply ignore when there is complete cure. There is no means of capturing patient feedback into their medical record after care and there are no systems that allows patients to enter their feedback directly into their medical records.

As the clinical journey of a patient may involve many medical service providers such as clinical labs, radiological imaging services, specialty medical or surgical centers or consultants. There is no system to proactively provide a consulting clinician at the point of care with the list of other medical service providers offering services to the particular lab test or a radiological investigation or a surgical procedure prescribed by the clinician.

### STATEMENT OF INVENTION

The embodiments herein achieve automated integration of user medical information from multiple healthcare service providers that allows the user to avail services from multiple healthcare service providers irrespective of services or location and have the medical data shareable automatically across all healthcare service providers. Referring now to the drawings, and more particularly to FIGS. 1 through 8, where similar reference characters denote corresponding features consistently throughout the figures, there are shown preferred embodiments.

### BRIEF DESCRIPTION OF FIGURES

This invention is illustrated in the accompanying drawings, through out which like reference letters indicate corresponding parts in the various figures. The embodiments herein will be better understood from the following description with reference to the drawings, in which:

FIG. 1 illustrates a system, according to embodiments as disclosed herein;

FIG. 2 illustrates a Patient Identification/Unique Identifier Generation process, according to embodiments as disclosed herein;

FIG. 3 illustrates Outpatient Clinic Workflow, according to embodiments as disclosed herein;

FIG. 4 illustrates a Lab/Radiology/Imaging testing center workflow, according to embodiments as disclosed herein;

FIG. 5 illustrates a Patient Web Client process, according to embodiments as disclosed herein;

FIG. 6 illustrates creation of blood relationship links, according to embodiments as disclosed herein;

FIG. 7 illustrates Drugs and Pharma firms' workflow, according to embodiments as disclosed herein; and

FIG. 8 illustrates Services Mapping workflow, according to embodiments as disclosed herein.

### DETAILED DESCRIPTION OF INVENTION

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

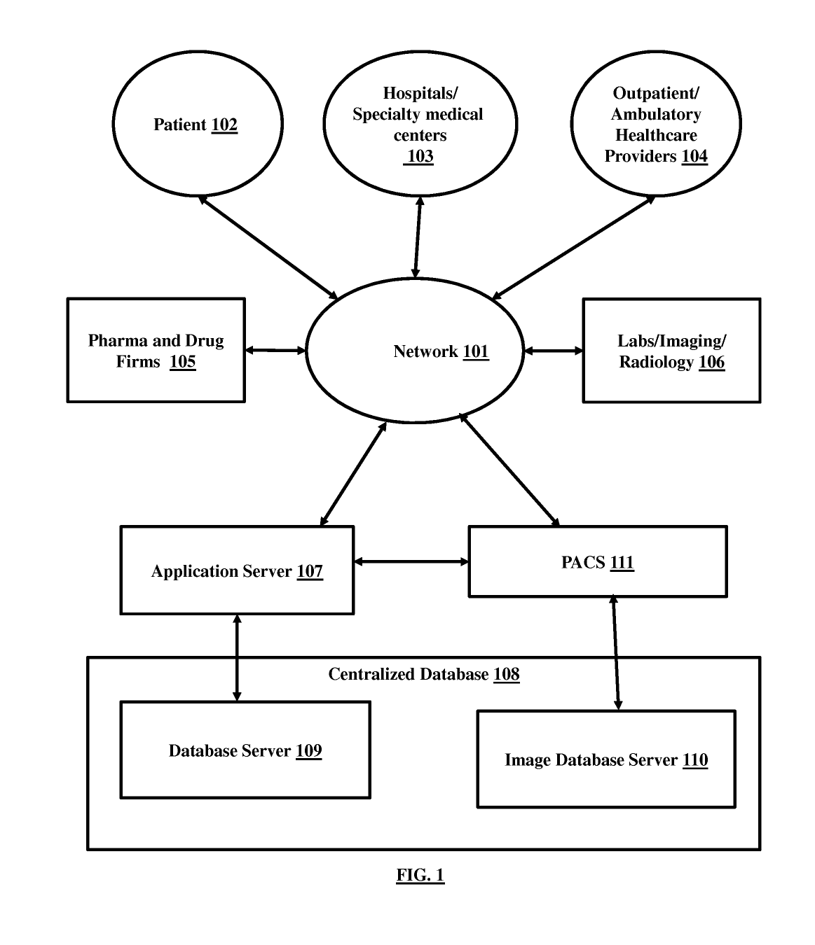

Referring now to the drawings, and more particularly to FIGS. 1 through 8, where similar reference characters denote corresponding features consistently throughout the figures, there are shown embodiments.

FIG. 1 illustrates a system, according to embodiments as disclosed herein. The system as depicted comprises of a network 101, pharma and drug firms 105, at least one patient 102, at least one hospital/poly clinic/special medical center 103, at least one outpatient/ambulatory healthcare provider 104, at least one laboratory/imaging/radiology center 106, an application server 107, a Picture Archiving and Communication Server (PACS) 111 and a centralized database 108. The network 101 may be any suitable communication network such as the internet and the user may be a patient 102. The network 101 enables the pharma and drug firms 105, the patient 102, the hospital/poly clinic/special medical center 103, the outpatient/ambulatory healthcare provider 104, laboratory/imaging/radiology center 106 to access information present in the centralized database 108, with the help of the application server 107 and the PACS 111. The laboratory/imaging/radiology center 106 represents all forms of independent healthcare service providers such as Individual General Practitioner and Consultant outpatient clinics, Poly clinics, Specialty medical and Surgical centers, Hospitals, Clinical Labs, Radiology and Imaging centers all serving Patients 102, varying in size, nature and combination of services. The laboratory/imaging/radiology center 106 capture, store and distribute patient medical information such as clinical findings, drug prescriptions, lab tests/results, Radiology Images and reports, surgery report, discharge summary, etc. The laboratory/imaging/radiology center 106 use their respective web client of a common application run by Application server 107 and a centralized database 108 over network 101 which comprises of their private networks connected internet to capture, store and distribute patient medical information.

The patient 102 is a user of the services offered by the pharma and drug firms 105, the hospital/poly clinic/special medical center 103, the outpatient/ambulatory healthcare provider 104 or the laboratory/imaging/radiology center 106. The patient 102 uses a unique ID to access his medical records available in the centralized database 108 and to identify himself to the service providers. The service providers may be any one of the pharma and drug firms 105, the hospital/poly clinic/special medical center 103, the outpatient/ambulatory healthcare provider 104 or the laboratory/imaging/radiology center 106. The medical records of the patient 102 may comprise of the medical history of the patient, tests taken by the patient 102 and their results, analysis of the test results, links to family members and so on. The unique ID is generated using the demographic information like the first name of the patient 102, the last name of the patient 102, date of birth of the patient 102, maiden name of the patient's mother and so on. Further demographic information may be requested from the patient 102 till a unique ID can be generated using the provided demographic information. The patient 102 may use the unique ID to access his medical records from the centralized database 108 using the network 101.

The data captured from the patient 102 is stored in the Centralized Database 108. The centralized database 108 comprises of at least, a Database Server 109 that stores medical record data and an Image Database Server 110 that stores image related medical record data of the patient 102. Electronic information stored on the Database Server 109 may include but not limited to patient's medical records (alpha numeric data), as entered by hospital/poly clinic/special medical center 103, outpatient/ambulatory healthcare provider 104 and laboratory/imaging/radiology center 106 from their point of care. Information includes links to records of relatives of the patient 102 entered using dedicated relationship codes in the system, drug information such as generic as well as trade names, drug interactions, dosage calculation, allergies and contra indications, etc., that is entered and updated by the respective pharma and drug firms 105 and all mapped to disease and clinical findings codes such as ICD 10 and SNOMED etc. Information also includes information on healthcare service providers and various medical services provided by them and the information is mapped to standard procedure codes in SNOMED, ICD 10 or system proprietary codes.

Image related medical record data stored on the Image Database Server 110 may include, but not limited to, images with respect to x-ray, ultrasound, magnetic resonance, Computed tomography, etc of the patient 102. The patients 102, hospital/poly clinic/special medical center 103, outpatient/ambulatory healthcare provider 104, pharma and drug firms 105 and laboratory/imaging/radiology center 106 use web-clients to communicate with the Application Server 107 and commonly known load-balancing techniques may be used for optimal resource utilization, minimize response time and avoid overload. SSL (Secure Socket Layer) Accelerators may be used at the Application Server 107 end to reduce the load further by offloading the processor intensive encryption algorithms involved in SSL transactions to a hardware accelerator. The Application Server 107 may be used to store and retrieve medical record data from the Database Server 109. The Application Server 107 may be configured to query image related medical record data from the Picture Archiving and Communications System (PACS) 111. PACS 111 enables patients to store image information using DICOM association over a secure VPN connection over the Network 101 from their imaging modalities directly or from their in house PACS systems. The Application server's 107 web client allows the patient 102 to retrieve relevant medical images from the Image Database server 110 through a link to a web server which is part of the PACS 111. The PACS 111 web server can display images on a separate web page.

Data in the Centralized Database 108 may be stored in the form of independent data groups including but not limited to List of healthcare service providers, Drug related information (dosage, generic names, specific trade names etc.), Electronic medical records of all patients associated with the Unique Patient ID, Family tree information as entered by the patients, and Data access rights of patients 102.

The Centralized Database 108 may allow for querying, modification and updation of data and plugging in of more data groups.

Patients 102 of the system, such as healthcare service providers including physician offices, poly clinics, hospitals, Labs, Radiology centers, as well as pharmaceutical firms, can use their respective web clients to access the system which will be configurable based on their requirements. The system offers modules based on specialities like Obstetrics, Dental, Surgical, Internal medicine etc., and also based on locations such as Outpatient, Inpatient, Theater, etc. Clinical labs and Radiology centers can have modules to input their test results and reports.

The system fully complies to the Standards for Privacy set by Individually Identifiable Health Information (Privacy Rule) issued by the US Department of Health and Human Services in order to implement The requirement of Health Insurance Portability and Accountability Act of 1996 (HIPAA). In addition, the system would comply with Country specific rules and regulations on patient information. Various subscribers such as Healthcare providers, Insurance firm will fall under “Covered entities”. The service provider of the proposed application is a “Business Associate” of “Covered entities”. The subscriber and the “Business Associate” can enter into an agreement on Disclosure of Individually identifiable Health Information within the boundaries of the rule. The patient 102 and/or the owner of his/her personal health information will have to authorize and give access rights to the current service provider who is a covered entity who is different from previous service providers who generated past records. Patient will be able to authorize or de authorize his/her relatives from accessing the information. By creating a relationship link the patient 102 can allow his/her record(s) to be shared with any other user in the network. The patient will have to agree to a standard terms and conditions before creating the link. However, the system has a facility for the patient 102 to selectively de-authorize a direct or indirect blood link, from sharing the information. De Identified health information (any information without patient identifier information) will be used for records sharing used in Evidence reporting, statistical results, pharma drug usage pattern, results, etc. Labs and Imaging centers will be able to share test results only with the patient 102 and the prescribing clinician. The service providers using third party reporting services will enter into a business associate contract agreement in the system to be agreed by both the parties.

Upon registration of the patient 102 at one of the healthcare service provider such as a physician clinic or a hospital, the patient's first name, last name and date of birth are entered in the system. The system queries the database server 109 for any earlier entry of the patient 102. If the patient 102 is a first timer to the system, then the system will generate a unique patient ID in the database server using a built in algorithm that uses the patient's first name, last name and date of birth as unique identifying factors. If the system finds entries in the database with similar first name last name and date of birth but not belonging to the same patient 102, unique identifying factors such as Mother's first name, followed by father's first name, etc., will be used to create the unique ID for the patient 102.

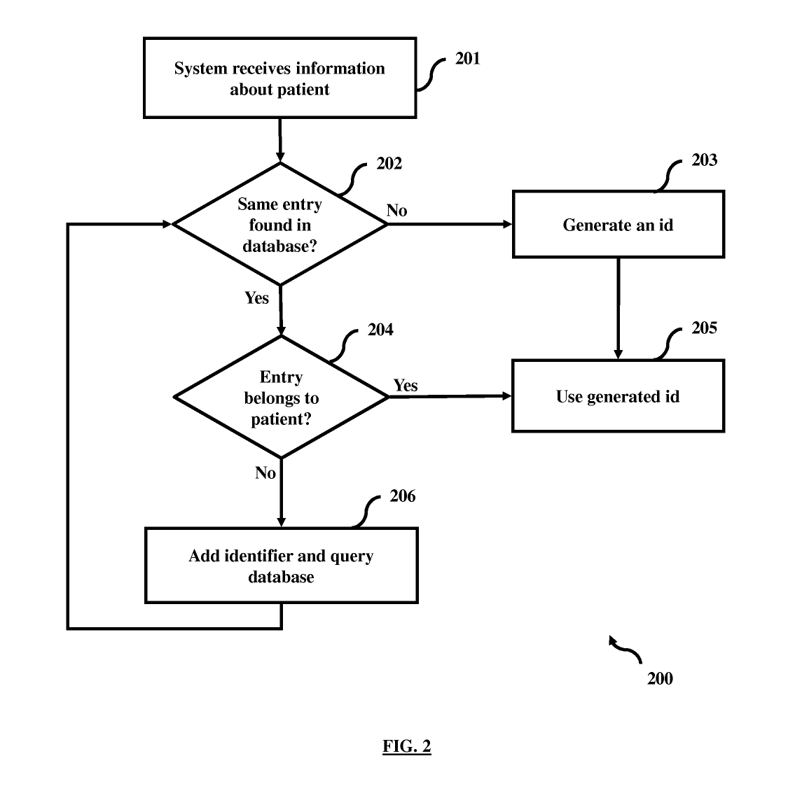

FIG. 2 illustrates a Patient Identification/Unique Identifier Generation process. A patient 102 has to register at one of the healthcare service provider such as a physician clinic or a hospital before the patient 102 can have his/her details entered onto the system. During registration the systems receives (201) information from the patient 102. The information may be the patient's 102 first name, last name and date of birth. The system queries (202) the database server 109 for earlier entry of the patient 102. If the patient 102 is a first time patient to the system, the system will generate (203) a unique patient ID in the database server 109 using a built in algorithm that uses the patient's 102 first name, last name and date of birth as unique identifying factors. The generated id can then be used (205) by the patient 102. If the system finds entries in the database with similar first name last name and date of birth but the entries do not belong (204) to the patient 102, then the system adds (206) further unique identifying factors such as Mother's first name, followed by father's first name, etc., to create a unique ID for the patient 102. The various actions in method 200 may be performed in the order presented, in a different order or simultaneously. Further, in some embodiments, some actions listed in FIG. 2 may be omitted.

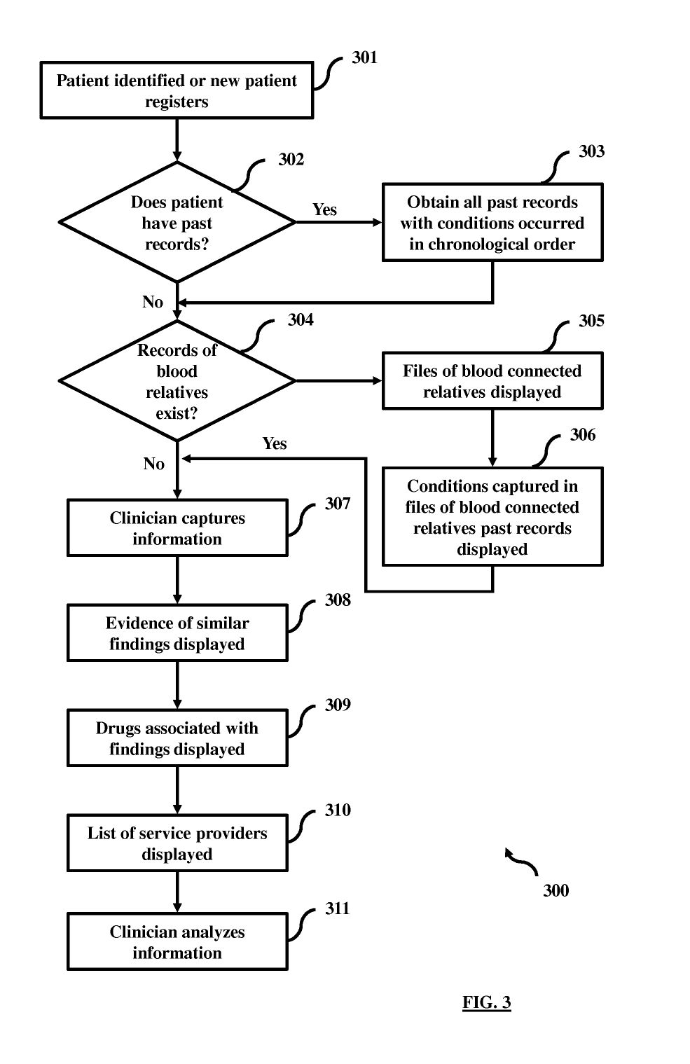

FIG. 3 illustrates an example of an Outpatient Clinic Workflow. If the patient 102 has registered with the system, then the patient 102 can log into (301) the system at a later point in time or a new patient 102 can register and log into the system. When the patient 102 logs into the system, the system checks to determine (302) if the patient 102 has any previous records with the system. When the patient 102 has previous records in the system, upon entry of first name, last name, and DOB of the patient 102, the system may list out the patient ID with demographic details, or a list of all different patient IDs having same first name, last name and DOB if any, along with demographic details. Headers/Links of the entries would be displayed chronologically as recorded by all Healthcare service providers. The patient 102 can identify the right list and approve the list. Once identified, the system will query the database and will obtain (303) list of relevant records with conditions of the patient 102 at the same healthcare provider as well as other episodes captured at other service providers. Allergies or any highlighted clinical conditions captured in the past records are displayed. The healthcare provider will be allowed to access the past entries of the patient 102 captured by the same provider along with test results and reports provided by other test service providers upon prescription by the service provider. However, the healthcare provider will be able to access past entries of the patient 102 captured by other health care providers such as another physician or another hospital only upon approval by the patient 102 which is done by the patient 102 through his/her respective web client. Further, the system checks to determine (304) if the patient 102 has any linked records of blood relatives with the system. If there are linked records existing of blood relatives, the system will also list out (305) links to past entries of blood relatives and some highlights from those entries. The system can be configured to do automated search within the patient data files residing in the database server 109 using keywords, codes and mappings to provide the clinician with proactive information on patient history and medical history of blood relatives. The system can be configured to identify certain coded clinical conditions, allergies etc., as highlights. This is achieved by searching the patient files in the database and providing information in the form of, but not limiting to, links to past records of patients, links to past records of patient's blood relatives, links to blood related patient files who have matching clinical findings, links to other patient files having similar clinical findings, most commonly prescribed lab, radiological tests, therapies for the clinical findings, most commonly prescribed drugs for the clinical finding, statistical usage of drugs, feedbacks from patients with similar clinical findings, links to files of patients with similar clinical symptoms but differently diagnosed etc., Allergies or any highlighted clinical conditions captured in the blood connected relatives' past records would be displayed (306).

Furthermore, the clinician may use respective data fields to capture information (307) such as allergies, past medical history as explained by the patient 102, his clinical findings Lab and radiology 106 prescriptions, drug prescriptions, notes, referral notes, etc. The system allows the healthcare provider to capture vital signs, symptoms, provisional/final clinical findings in the coded form (ICD 10 or SNOMED), prescribe diagnostic tests and/or drugs from pre registered tests and drug lists. Evidence of similar clinical findings in the past records of the patient or relatives would be displayed (308) as links to the files. Evidence of the clinical findings in other patient files is displayed as links. Information on treatment of patients with similar clinical findings, information on lab and radiological 106 investigations performed, drugs prescribed to the patients with similar findings would be retrieved from the system. Reports such as most prescribed lab or radiology test or drugs for the clinical findings in other records are also displayed. Drugs associated to the clinical findings are also displayed (309). If the clinician chooses to use the drugs, then the system calculates the dosage based on the formula set up by the drug firm with inputs to the formula being data such as age of the patient 102, weight of the patient 102, etc. Alerts on contra indications and drug interactions can pre configured into the system by the drug firm. List of lab, radiology 106 service providers, specialty healthcare providers offering the specific test or procedure as service would be displayed (310) based on the requirements.

Once the patient 102 information has been uploaded or updated on a particular patient ID, a message will be sent to the owner of the patient ID as an SMS and/or an email along with the updated information. The information displayed about the patient 102 would be received (311) by the clinician as messages on his console when the patients 102 lab, radiology 106 reports from other service providers are completed and is available. The clinician can review and analyze (3012) results of lab exams, radiological exams from his console. The various actions in method 300 may be performed in the order presented, in a different order or simultaneously. Further, in some embodiments, some actions listed in FIG. 3 may be omitted.

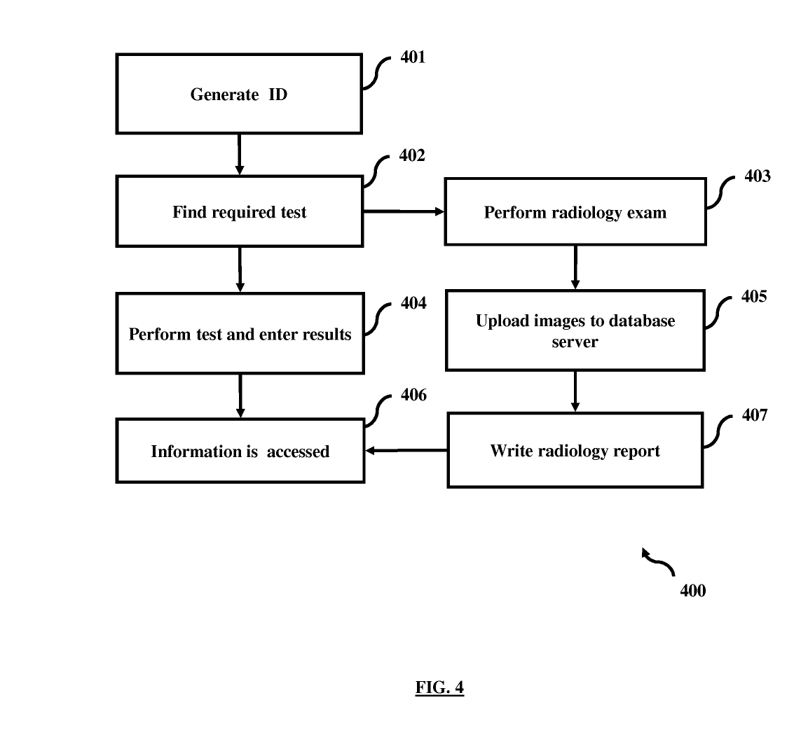

FIG. 4 illustrates a Lab/Radiology/Imaging testing center workflow. Clinical labs and radiology service centers use their respective web clients to query, fetch and validate patient ID with first name last name and DOB. If the patient 102 does not have a patient ID, then a unique ID is generated (401). The system lists the tests to be performed (402) for the patient ID and the prescriber details. The tests are performed the results/reports and entered (404) through the assigned fields. Radiology centers use the same patient ID, generated by the system, on the scanning device to perform the radiology exam (403) and the images will be uploaded (405) directly, or after image quality assurance, to the PACS 111 and the database server 109. After the radiology exam is complete, the radiology report is written (407). Once the results are uploaded by the lab or radiology center, the prescribing healthcare provider will get a pop up message on his screen indicating the readiness of the report/results. The healthcare provider will be able access (406) the test results from the entry page when the request for images is selected, the application server will call the PACS 111 web server to display the images using the PACS web application on a separate web page. The various actions in method 400 may be performed in the order presented, in a different order or simultaneously. Further, in some embodiments, some actions listed in FIG. 4 may be omitted.

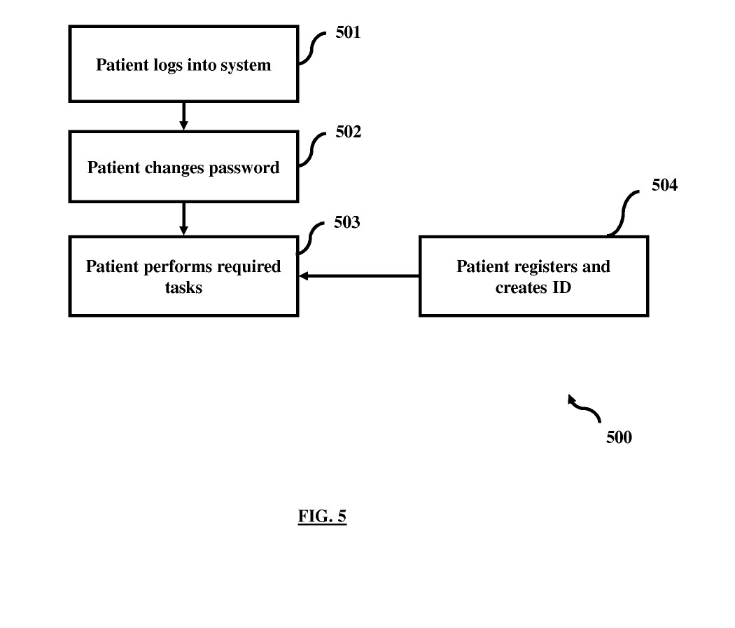

FIG. 5 illustrates a Patient Web Client process. Patients 102 would be able to access the system, register and create their patient ID by themselves or avail an ID from an episode at a healthcare provider and log into (501) their page using the ID and default changeable password. If the patient 102 has not registered, then the patient 102 can register with the system and create (504) a unique ID for the patient 102. The patient 102 may choose to change (502) the password and perform (503) the required tasks. The patient 102, being the sole owner of his/her information, will be able to access his/her medical information, choose service providers for lab, radiology or referral consultants as prescribed by the primary healthcare provider and as recommended by the system based on the specific test or procedure required to be done. The patient 102 will also be able to assign access rights to other healthcare providers to access past entries. The various actions in method 500 may be performed in the order presented, in a different order or simultaneously. Further, in some embodiments, some actions listed in FIG. 5 may be omitted.

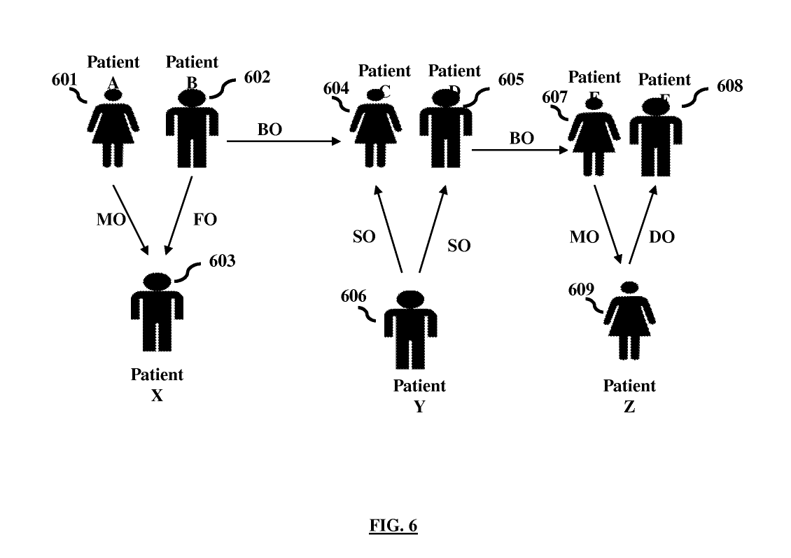

FIG. 6 illustrates creation of blood relationship links. The patient 102 will be able to create blood relationship links with other users and define the relationship code for the link. Other users may be other patients. The patient 102 receiving such relationship link from another patient may deny the link and in such case the link will not be established. The system may be further configured to not permit multiple relationship links between the same set of patients. The system may comprise of predefined relationship codes including but not limited to:
FO—Father of (Creator of relationship link is father and recipient is son/daughter.)
SO—Son of (Creator of relationship link is the Son and recipient is Father/Mother).
DO—Daughter of (Creator of relationship link is the Daughter and recipient is Father/Mother).
MO—Mother of (Creator of relationship link is the Mother and recipient is Son/Daughter)
BO—Brother of (Creator of relationship link is the Brother and recipient is Brother/Sister).
SiO—Sister of (Creator of relationship link is the Sister and recipient is Brother/Sister).

The relationships may not be limited to blood relationships of Father, Mother, Son, Daughter, Brother and Sister. The relationship link may continue indirectly through the links created between blood relatives. Patient A 401 creates a relationship link MO with Patient X 403. Similarly Patient B 402 creates a relationship link FO with Patient X 403. Further Patient B 402 creates a relationship link BO with his brother i.e. Patient C 404. Patient C 404 is a recipient of a relationship link SO from Patient Y 406. Also Patient Y 406 has established a relationship link SO with Patient D 405. Patient D 405 has an already existing relationship link BO with Patient E 407. Patient E in turn has established a relationship link MO with Patient Z 409 who has an already existing relationship link DO with Patient F 408. In this Family Linkage 400 Patient A 401 and Patient B 402 being father and mother who are not blood related get connected through their son Patient X 403 and there is no direct connectivity between Patient A 401 and Patient B 402. Similarly Patient Y 406 is indirectly connected to Patient Z 409 through a relationship link between Patient D 405 and Patient E 407. This system may be configured to automatically invalidate and not permit certain relationship links to ensure direct connectivity between blood relatives and indirect connectivity between relatives who are not blood linked. This technique of Family Linkage 400 will work with any number of non-blood relatives being linked.

Search paths having the following links will make the path invalid:

### FO&C→MO&R

### MO&C→FO&R

### SO&R→SO&C

### DO&R→DO&C

### FO&C→SO&C

### FO&C→DO&C

### SO&R→FO&R

### DO&R→FO&R

### MO&C→SO&C

### MO&C→DO&C

### SO&R→MO&R

### DO&R→MO&R

C is the creator of the relationship
R is the recipient of the relationship
However, father and mother who are actually blood linked through other relationships will remain blood linked through appropriate other relationship links. This is also valid for a father having children through many wives and the vice versa.

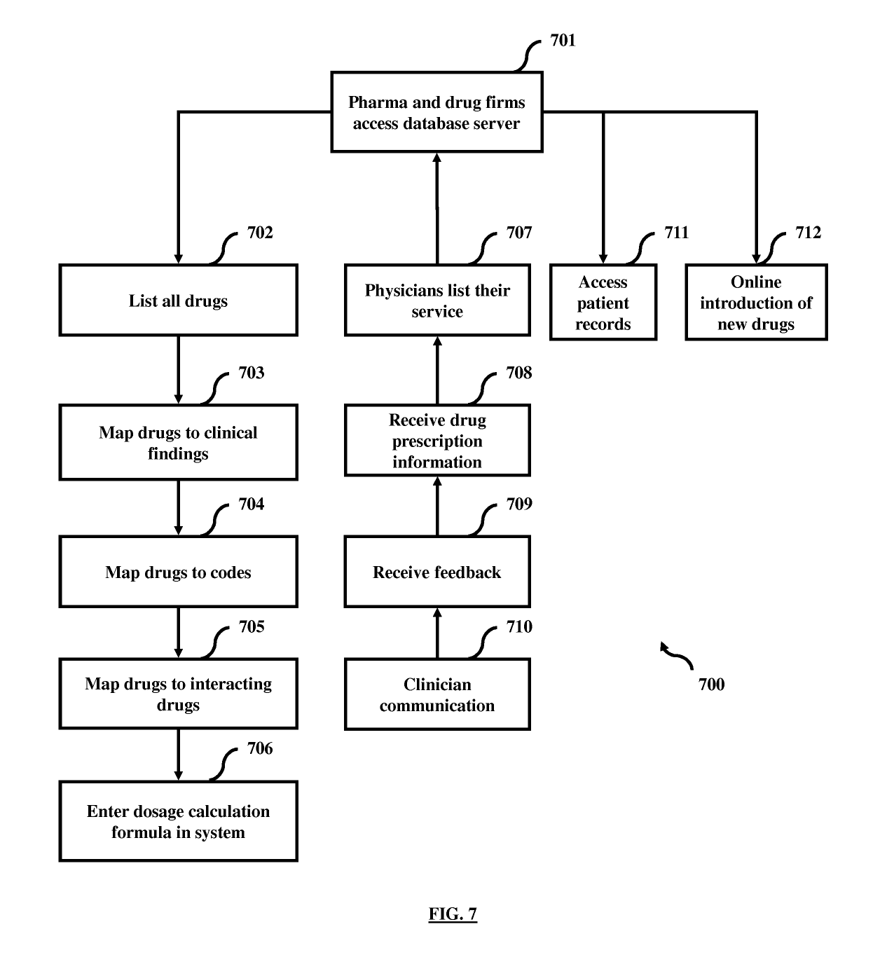

FIG. 7 illustrates Drugs and Pharma firms' workflow. The system would be configured to allow pharma and drug firms 105 access the system directly using their web client to enter their drugs information such as Generic Names, Trade Names, dosage calculation info, and map this info to relevant coded clinical symptom or findings in the system, map to interacting drugs, map to coded clinical conditions for allergies and contraindications, The system will also allow pharma firms 105 update their list, introduce new drugs, withdraw drugs, highlight important information or news about the drug to the clinician at point of care, receive alerts on wrong prescriptions by the clinician, study drug utilization pattern and effectiveness etc., Pharma firms will be able to access files of patients prescribed with their drugs (with appropriate rights and permissions). Pharma and drug firms 105 use their web client to access (701) the database server 109. The pharma and drug firms 105 list (702) all their drugs with Generic as well as trade names along with information of region of usage, detailed description of drugs. The pharma and drug firms 105 map (703) the drugs to clinical findings codes (NOMED, ICD 10) in the system. The pharma and drug firms 105 map (704) the drugs to contraindication codes and also map (705) the drugs to interacting drugs. The pharma and drug firms 105 then enter (706) the dosage calculation formula in system readable format.

A clinician can also communicate (710) with the pharma and drug. The pharma and drug firms 105 can receive (709) patient feedback from the clinician and receive clinician feedback from the patient 102. The pharma and drug firms 105 can also receive (708) drug prescription information from Point of care along with Associated clinical findings of clinician. The pharma and drug firms 105 can access (711) patient clinical records for assessment of effects of drug on patients. The pharma and drug firms 105 can implement and manage (712) online introduction of new drugs, online withdrawal of drugs and alerts at Point of care. The various actions in method 700 may be performed in the order presented, in a different order or simultaneously. Further, in some embodiments, some actions listed in FIG. 7 may be omitted.

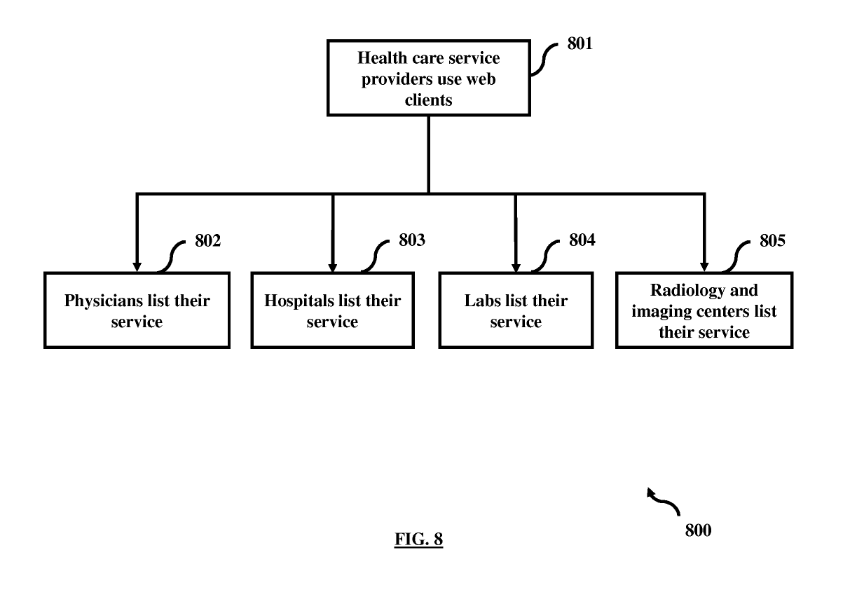

FIG. 8 illustrates Services Mapping workflow. The system would be configured to allow healthcare service providers, including, but not limiting to, clinical Labs, Radiology and Imaging centers (106) to list their services and map the names of the tests and procedures with system recognizable services. This is achieved by mapping their services with procedure codes used in the system such as ICD and/or SNOMED. This would enable prescribing clinicians to be proactively indicated with a list of service providers offering the specific prescribed test(s) or procedures. Healthcare service providers use their respective web clients and system codes to list (801) their services. Physicians can list (802) their service as Specialty consultation and map the service to the system code. Physicians may add/update services with additional codes as and when a new service is added. Hospitals list (803) their all their services including specialty consultations ICU care, inpatient surgical procedures Lab and radiology services and map the services to system codes. Labs list (804) all their test services and map the same to system codes. Radiology and Imaging centers list (805) their imaging services and map the tests to the system codes. The various actions in method 800 may be performed in the order presented, in a different order or simultaneously. Further, in some embodiments, some actions listed in FIG. 8 may be omitted.

### EXAMPLES OF A CLINICAL SCENARIOS

### Example 1

Jones is pregnant and visits an Obstetrician. Jones has most of her blood relatives' medical records for more than 35 years on the database and all linked thro relationship codes. Dr. Laila, Jones' obstetrician enters Jones's demographics in her portal and the portal indicates that Jones has:

53 Records of blood relatives,
12 Records with Diabetes Mellitus (ICD E10, E11).
5 Records with Diabetes Mellitus arising in pregnancy (ICD O24.4).
8 Records with . . .
14 Records with . . .
1 Record with Obstetric Death of unspecified cause (ICD O95)
Doctor goes through the some of these past records and determines Jones may have a possibility for High Risk Pregnancy. She determines her clinical pathway based on the family history.

### Example 2

Dr. Raja is a practicing GP in Naamakkal, India and he had a patient with symptoms of high fever, cough, sore throat and body ache. Raja suspects H1N1, but he neither has previous experience in treating H1N1 nor knows clinical management of H1N1. He enters his clinical provisional diagnosis from the ICD “pull down menu” or an ICD search for H1N1 in his portal as follows.

### Date:

### Patient Name:

### First: Last:

### Patient ID: . . . DOB: . . .

### Sex:

### History: . . .

### V/S:

Temp: . . . HR: . . . BP: Sys: . . . mmHg Dia: . . . Mm Hg

### Chief Compliant: . . .

Clinical findings: . . .

### Provisional or

suspected diagnosis: H1N1

Influenza due to identified avian influenza virus ICD J09

The system automatically performs a query into all records in the database and the portal indicates info on past records as follows:

232 Records with J09 Influenza due to identified avian influenza virus
5 Records from Pune, India
2 Records from Bangalore, India
RT-PCR test prescribed in 191 records
TamiFlu prescribed in 221 records
Dr. Raja goes through some past records from India as well as the US from the above links. He appraises the clinical pathways adopted, critically. He decides to perform further investigations to rule out H1N1. Dr. Raja decides to get RT-PCR test done for the patient. He requests for RT-PCR test in the Lab Investigation window in the portal. The portal lists the diagnostic labs nearer to Nammakkal capable of conducting RT-PCR test as follows, on a side window.

### Sri Devi Diagnostic Center, Coimbatore:

Dr. Raja sends patient for testing immediately. Sri Devi Diagnostic Center conducts the test and report H1N1 positive in the patient's ID in the portal. Dr. Raja also gets a message on his console test result. He reviews the lab results and writes his final diagnosis as follows:
J09 Influenza due to identified avian influenza virus:
The system lists out drugs associated to the above clinical conditions on a side tray Oseltamivir TamiFlu

### Zanamivir Relenza

Dr. Raja clicks on the drugs to read more info on the drugs. Also, as he had earlier gone thro some records of H1N1 and the course of treatment adopted by those physicians, he finally decides to prescribe TamiFlu. When he entered his prescription in the portal, the system calculates the dosage based on weight, age and the pre-defined formula in the system. Hence Dr. Raja successfully diagnosed and started medication for H1N1 within few hours based on the evidences available in the database and the drugs associated to ICD J09.

The embodiments disclosed herein can be implemented through at least one software program running on at least one hardware device and performing network management functions to control the network elements. The network elements shown in FIG. 1 include blocks which can be at least one of a hardware device, or a combination of hardware device and software module.

The embodiment disclosed herein describes automated integration of patient medical information from multiple healthcare service providers that allows the patient to avail services from multiple healthcare service providers irrespective of services or location and have the medical data shareable automatically across all healthcare service providers. Therefore, it is understood that the scope of the protection is extended to such a program and in addition to a computer readable means having a message therein, such computer readable storage means contain program code means for implementation of one or more steps of the method, when the program runs on a server or mobile device or any suitable programmable device.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the embodiments as described herein.

What is claimed is:

1. A method of providing evidence medical practice based on patient history and family history using an electronic patient medical information system, the method comprising:
creating an unique patient identifier for the patient;
updating patient healthcare activity by creating a medical visit record for each patient visit to a healthcare providing institution or a individual healthcare provider;
storing visit records in the electronic patient medical record data associated with the patient visit into a centralized database using the unique patient identifier for the patient, wherein said centralized database is accessible across plurality of healthcare providing institutions and individual healthcare providers; and
creating a family linkage using one or more unique patient identifiers to connect individual medical records of relatives of the patient through predefined relationship codes.

2. The method of claim 1, the method further comprising:
linking directly or indirectly linked patient files through pre-defined relationship codes;
disqualifying invalid blood links in the chain of linked patient files; and
creating a valid genomic tree of patients with medical data residing in the centralized database.

3. The method of claim 2, the method further comprising:
obtaining links to data of one or more of blood connected individual's using the genomic tree of patient IDs; and
highlighting clinical evidence in the blood connected individual's data relevant to the clinical findings of the patient using coded clinical terms, when a clinician enters clinical findings in the system.

4. The method of claim 2, the method further comprising:
obtaining files of patients with similar clinical findings using coded clinical terms; and
providing links to the obtained files at point of care,
when a clinician enters clinical findings in the system.

5. The method of claim 2, the method further comprising:
obtaining files of patients with similar clinical findings using coded clinical terms; and
providing information on at least most prescribed tests, investigations, procedures and drugs for the clinical finding, when a clinician enters clinical findings in the system.

6. The method of claim 2, the method further comprising:
obtaining files of patients with similar clinical findings using coded clinical terms; and
providing statistical information on clinical findings, when a clinician enters clinical findings in the system.

7. The method of claim 6, wherein the statistical information comprises at least one among:
number of matching records with respect to one or more clinical findings in a selected geographical region;
most prescribed procedures and drugs such as surgical procedures, clinical lab tests, radiological investigations for one or more reported clinical findings;
most commonly reported clinical diagnosis for one or more radiological findings; and
differential diagnosis for one or more reported clinical findings.

8. The method of claim 1, further comprising creating a unique family linkage identifier for every family linkage.

9. A method of introducing a new drug to a point of care using an electronic patient medical information system, the method comprising:
listing the drug into the system;
mapping the generic and trade names of the drug with system coded clinical findings;
mapping drugs to counteracting drugs, allergies, and contraindications; and
listing a formula for calculating dosage using a system recognizable format.

10. The method of claim 9, the method comprising:
pointing out the drug when associated clinical findings are captured at the point of care; and
calculating the dosage of the drug chosen based on pre-determined input parameters relating to the patient.

11. The method of claim 9, the method comprising pointing out contradictions when a counteracting drug, allergy, or contraindication is found.

12. An electronic patient medical information system performing a method comprising:
listing the drug into the system;
mapping the generic and trade names of the drug with system coded clinical findings;
mapping drugs to counteracting drugs, allergies, and contraindications; and
listing a formula for calculating dosage using a system recognizable format.

13. The system of claim 12, wherein said method further comprises:
pointing out the drug when associated clinical findings are captured at the point of care; and
calculating the dosage of the drug chosen based on pre-determined input parameters relating to the patient.

14. The system of claim 12, wherein said method further comprises pointing out contradictions when a counteracting drug, allergy, or contraindication is found.
